(19) United States
(12) Patent Application Publication
(10) Pub. No.: US 2007/0140934 A1
(43) Pub. Date: Jun. 21, 2007

(54) Catalyst supply device

(75) Inventors: Masahiro Okamura, Chiba (JP); Masakatsu Kuroki, Chiba (JP); Yasunobu Kaneko, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd, Tokyo (JP)

(21) Appl. No.: 10/581,526

(22) PCT Filed: Dec. 3, 2004
(86) PCT No.: PCT/JP04/18023

§ 371 Date: Dec. 26, 2006

(30) Foreign Application Priority Data
Dec. 5, 2003 (JP) 2003-407975

(51) Int. Cl. B01J 4/00; B01J 8/00

(52) U.S. Cl. 422/232

(57) ABSTRACT

A catalyst supply device (1) has a catalyst vessel (2) in which catalyst slurry (10) is placed; an automatic suction valve (3) connected to the downstream side of the catalyst slurry supply vessel (2); three-way piping (4) for connecting the automatic suction valve (3), automatic discharge valve (6), and a positive displacement pump (5); and the positive displacement pump (5) and the automatic discharge valve (6) that are connected to the three-way piping (4). The catalyst supply device (1) supplies the catalyst slurry (10) to a reaction vessel (7) without causing a catalyst (11) to enter into the inside of the positive displacement pump (5).

### TECHNICAL FIELD

The present invention relates to a catalyst supply device, and specifically relates to the catalyst supply device for stably supplying catalyst slurry to a reaction vessel.

### BACKGROUND ART

In fabricating a chemical, in order to maintain a stable chemical reaction, it is necessary to stably supply a catalyst to a reaction vessel, that is to say, surely supply the same by a predetermined volume without variation in volume.

In particular, in fabricating polyolefin or the like, it is necessary to stably supply the catalyst containing a transitional metal component to the reaction vessel. The above-mentioned catalyst is blended with a solvent in a predetermined proportion to obtain catalyst slurry, and the same is supplied to the reaction vessel by means of the catalyst supply device provided with a positive displacement pump.

Conventionally, a variety of catalyst supply devices for stably supplying the catalyst slurry have been suggested.

For example, in the patent document 1, there is disclosed the technology of the catalyst supply device, wherein a rotating body having two flow paths, which do not cross to each other, is disposed in a carrier fluid flowing into the reaction vessel, and when the carrier fluid flows through one flow path, a high concentration catalyst is filled to the other flow path.

According to the technology, the high concentration catalyst may be appropriately supplied to the carrier fluid, by rotating the rotating body, so that the high concentration catalyst may be supplied to the reaction vessel with the carrier fluid.

And in the patent document 2, there is disclosed the technology of a volumetric supply device, including a casing with a storage room formed inside thereof, and with a slurry supply port, a carrier fluid supply port and a vacuum hole on an upper surface thereof, and with a discharge port connected to the storage room and is opposite to the carrier fluid supply port on a lower surface thereof; a rotating disc rotatably disposed in the storage room of the casing in close relation with the same, with a weighing hole, which conforms to the slurry supply port, the carrier fluid supply port, the discharge port and the vacuum hole in this order when rotating, pierced thereon; and a rotating shaft inserted into the casing and one end thereof is connected to the rotating disc to be rotationally driven.

According to the technology, the catalyst may be smoothly supplied, and the catalyst may be rapidly supplied to a container or the like.
Patent Document 1: Japanese Patent Application Laid-Open No. S58-127707
Patent Document 2: Japanese Patent No. 3097763

### DISCLOSURE OF THE INVENTION

### PROBLEM TO BE SOLVED BY THE INVENTION

However, the catalyst supply device disclosed in the Japanese Patent Application Laid-Open No. S58-127707 has a room for improvement from the viewpoint of supplying the catalyst slurry to the reaction vessel with higher accuracy, although this can supply the high concentration catalyst to the reaction vessel by making the carrier fluid carry the catalyst.

And as for the volumetric supply device disclosed in the Japanese Patent No. 3097763, although it is necessary to evenly drop the catalyst to fill a catalyst filling portion of the rotating body, it is technically difficult to fill a predetermined volume of the catalyst from the catalyst supply vessel to a small and rotating catalyst filling portion, so that it is not possible that the catalyst is stably supplied to the reaction vessel.

Furthermore, since the volumetric supply device utilizes a rotating device having a special structure, maintenance thereof is complicated, and in actual, the maintenance is difficult.

In order to solve the above-described problem, an object of the present invention is to provide the catalyst supply device capable of stably supplying the catalyst slurry to the reaction vessel.

### MEANS FOR SOLVING THE PROBLEM

In order to achieve the above object, a catalyst supply device according to the present invention is a catalyst supply device for supplying catalyst slurry from a catalyst slurry supply vessel to a reaction vessel by means of a positive displacement pump, and is structured such that the catalyst slurry supply vessel, the reaction vessel and the positive displacement pump are connected to one another by means of three-way piping, an automatic suction valve, which opens when the positive displacement pump sucks and closes when the pump does not suck, is interposed between the catalyst slurry supply vessel and a crossing of the three-way piping, an automatic discharge valve, which opens when the positive displacement pump discharges and closes when the pump does not discharge, is interposed between the reaction vessel and the crossing of the three-way piping, enclosed fluid is enclosed in the positive displacement pump and at least a part of piping between the positive displacement pump and the crossing of the three-way piping, and a predetermined volume of the catalyst slurry is sucked from the catalyst slurry supply vessel into the piping between the crossing of the three-way piping and the positive displacement pump through the automatic suction valve when the positive displacement pump sucks, and the predetermined volume of the catalyst slurry is discharged through the automatic discharge valve to be supplied to the reaction vessel when the positive displacement pump discharges.

Thus structured, it becomes possible to surely supply the predetermined volume of the catalyst, and since the catalyst slurry does not enter into the pump room of the positive displacement pump, a problem that the catalyst sediments in the pump room, thereby reducing the discharge volume or completely stopping discharge due to a blockage, can be inhibited, and the catalyst slurry can be stably supplied.

And, the catalyst supply device according to the present invention is structured such that the automatic discharge valve opens after the positive displacement pump starts discharge.

Thus structured, the catalyst slurry is pressurized up to a higher pressure than the inner pressure of the reaction vessel before the automatic discharge valve is opened, a problem that the positive discharge pump is shocked by the inner pressure of the reaction vessel, may be inhibited.

And, the catalyst supply device according to the present invention is structured such that the positive displacement pump is a diaphragm pump, and the fluid enclosed in the diaphragm assembly is the same as a solvent which is used to the catalyst slurry, further the piping between the crossing of the three-way piping and the positive displacement pump is placed above the crossing of the three-way piping.

By thus filling the piping between the crossing of the three-way piping and the diaphragm pump with the same solvent as is used to prepare the catalyst slurry, it becomes possible to inhibit a problem that interference occurs by mixing of the enclosed fluid and the solvent even when the solvent contacts the sucked catalyst slurry.

And it is more preferable that the diaphragm pump is structured such that the diaphragm assembly is filled with the same solvent as that of the catalyst slurry, and the catalyst slurry is not directly sucked in the diaphragm assembly, when the catalyst slurry is supplied to the reaction vessel. Thus structured, diaphragm pump may inhibit a problem that the catalyst slurry enters into the diaphragm assembly to block the pump.

And, in the catalyst supply device according to the present invention, the positive displacement pump, and the automatic suction valve, the automatic discharge valve and the crossing of the three-way piping are integrally structured.

Thus structured, a small and space-saving catalyst supply device may be obtained.

And, the catalyst supply device according to the present invention is structured such that an inner diameter of a flow path through which the catalyst slurry flows is set to be larger than 2 mm, and is set such that an average linear flow rate calculated from the flow volume of the catalyst slurry is larger than 3.0 cm/s.

Thus structured, the sediment of the catalyst due to a small flow rate may be inhibited, thereby inhibiting the piping blockage, and a long continuous running becomes possible.

And, the catalyst supply device according to the present invention is structured such that when providing a measurement instrument in the flow path of the catalyst slurry, a connection of the measurement instrument and the flow path is an inner nozzle structure.

Thus structured, it becomes possible to inhibit the flow path of the connection from enlarging, thereby inhibiting a problem that the catalyst sediments in the connection.

And, the catalyst supply device according to the present invention is structured such that the catalyst slurry supply vessel has an agitating blade.

Thus structured, it becomes possible to effectively inhibit the sediment of the catalyst, thereby maintaining the concentration of the catalyst slurry substantially homogeneous as a whole.

And, the catalyst supply device according to the present invention is structured such that a filter is provided in the flow path to supply the catalyst slurry to the catalyst slurry supply vessel.

Thus structured, a problem that the flow path is blocked by coarse grain of the catalyst may be inhibited.

And, the catalyst supply device according to present invention is structured such that the reaction vessel is the reaction vessel for fabricating polyolefin.

By thus using the catalyst supply device according to the present invention in a fabrication process of polyolefin, a stable chemical reaction may be realized, so that extremely high quality polyolefin may be fabricated.

### EFFECT OF THE INVENTION

According to the catalyst supply device of the present invention, the catalyst may be stably supplied to the reaction vessel, for example, in the fabrication of a chemical such as polyolefin without using a special rotating machine or the like.

### BRIEF DESCRIPTION OF THE DRAWINGS

FIG. 1 is a schematic block diagram of a catalyst supply device according to the present invention.

FIG. 2 is a schematic enlarged cross-sectional view for illustrating an inner nozzle structure of the catalyst supply device according to the present invention.

FIG. 3a is a schematic enlarged cross-sectional view of a state before starting suction, for illustrating an operation of the catalyst supply device according to the present invention.

FIG. 3b is a schematic enlarged cross-sectional view of a state just before completion of the suction, for illustrating the operation of the catalyst supply device according to the present invention.

FIG. 3c is a schematic enlarged cross sectional view of a state when completing the discharge, for illustrating operation of the catalyst supply device according to present invention.

### DESCRIPTION OF REFERENCE NUMERALS

1 catalyst supply device
2 catalyst slurry supply vessel
3 automatic suction valve
4 three-way piping
5 positive displacement pump
6 automatic discharge valve
7 reaction vessel
9 flow meter
10 catalyst slurry
10a, 10b, 10c, 10d catalyst slurry
11 catalyst
12 solvent
21 motor
22 agitating blade
40 crossing
41 suction valve side piping
42 discharge valve side piping
43 suction/discharge port side piping
51 suction/discharge port
52 diaphragm assembly
53 diaphragm
54 oil
55 inlet opening
81 piping
82 piping
83 valve
84 valve
85 return piping
86 inner nozzle
87 piping
91 inflow portion
92 connection
93 inner nozzle
94 filter
95 catalyst slurry supply source

### BEST MODE FOR CARRYING OUT THE INVENTION

[Catalyst Supply Device]

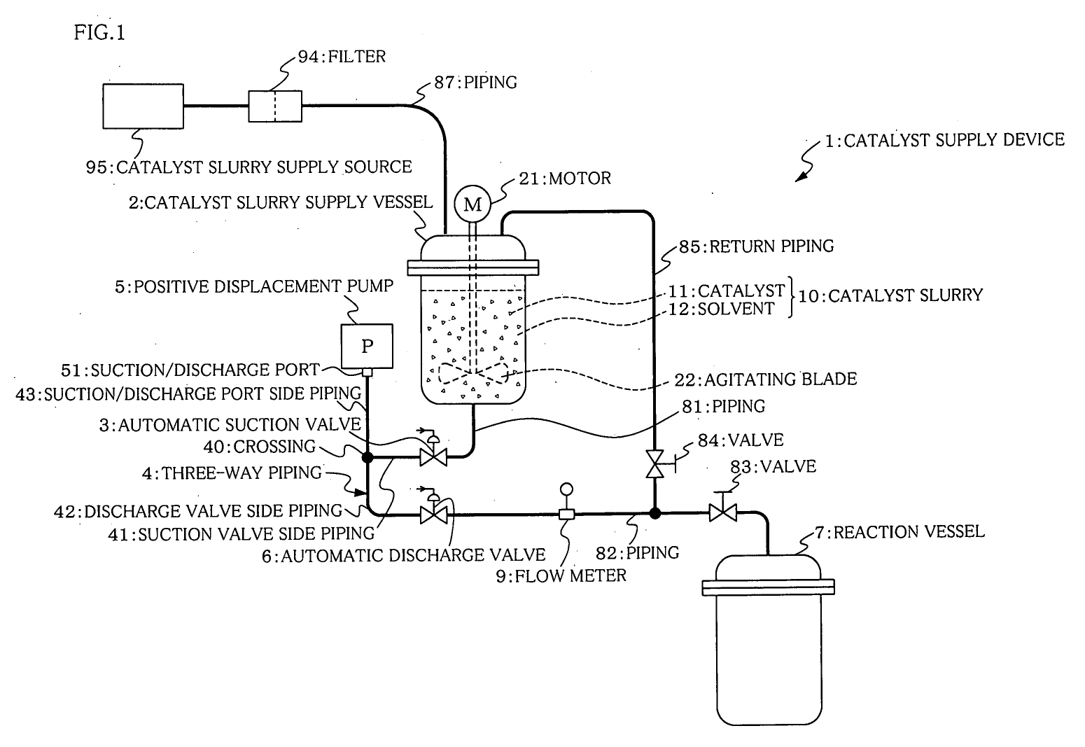

FIG. 1 shows a schematic block diagram of a catalyst supply device according to the present invention.

In the drawing, a catalyst supply device 1 is a device for supplying catalyst slurry 10 from a catalyst slurry supply vessel 2 to a reaction vessel 7 by means of a positive displacement pump 5, and includes three-way piping 4 connecting the catalyst slurry supply vessel 2, the reaction vessel 7, and the positive displacement pump 5 to each other, an automatic suction valve 3 interposed between a crossing 40 of the three-way piping 4 and the catalyst slurry supply vessel 2, and an automatic discharge valve 6 interposed between the crossing 40 of the three-way piping 4 and the reaction vessel 7.

A pressure container is generally used as the catalyst slurry supply vessel 2, and the catalyst slurry 10 prepared with a catalyst 11 and a solvent 12 in a predetermined proportion is placed therein.

As the predetermined proportion, in general, approximately 50 to 500 g of the catalyst 11 is dissolved in approximately 1 L of the solvent 12.

Herein, preferably, approximately 50 to 250 g of the catalyst 11 may be dissolved in approximately 1 L of the solvent 12.

This is because, when a concentration is lower than approximately 50 g/L, there may be a case in which a volume of the solvent 12 placed in the reaction vessel 7 increases, the case being unfavorable in quality of products, and when the concentration is higher than approximately 250 g/L, the catalyst 11 may sediment in the piping or the like, thereby allowing a blockage to occur at high risk.

And, it is preferable to provide an agitating blade 22 driven by a motor 21 inside of the catalyst slurry supply vessel 2, thereby effectively inhibiting sediment of the catalyst 11 to maintain the concentration of the catalyst slurry 10 substantially homogeneous state as a whole.

Meanwhile the catalyst 11 is the catalyst necessary for a reaction in the reaction vessel 7, and the solvent 12 is a solvent inactive against a catalyst component and a monomer for polymerization.

The catalyst containing a transitional metal component used for fabricating polyolefin or the like, for example, may be used as the above-described catalyst 11. And the catalyst 11 is not limited to a raw catalyst, and a pre-polymerized catalyst may also be used, for example.

The automatic suction valve 3 is connected to a downstream side of the catalyst slurry supply vessel 2 by means of piping 81. The automatic suction valve 3 is automatically controlled to open when the positional displacement pump 5 sucks and to close when the pump 5 discharges.

The automatic suction valve 3 of this embodiment includes a gate valve and a pneumatic actuator (not shown) for controlling opening and closing of the gate valve, and is controlled to open when the positive displacement pump 5 sucks and to close when the pump 5 does not sucks, by an operation of the pneumatic actuator in conjunction with an operation of a diaphragm 53 of the positive displacement pump 5.

Meanwhile, the automatic suction valve 3 is not limited to the above structure, and an electromagnetic valve operating in conjunction with the operation of the diaphragm 53 may also be used, for example. And, the valve 3 is not limited to the gate valve.

The three-way piping includes the piping 81, piping 82, suction valve side piping 41, discharge valve side piping 42, and suction/discharge port side piping 43 of the positive displacement pump 5, and one end of each of the suction valve side piping 41, the discharge valve side piping 42, and the suction/discharge port side piping 43 of the positive displacement pump 5 are connected to each other at the crossing 40. And, as for the other ends opposite to the crossing 40, the suction valve side piping 41 is connected to the automatic suction valve 3, the discharge valve side piping 42 is connected to the automatic discharge valve 6, and further, the suction/discharge port side piping 43 is connected to the suction/discharge port 51 of the positive displacement pump 5.

And, the three-way piping 4 is structured such that the suction/discharge port side piping 43 is located on a portion higher than the crossing 40 so as to inhibit the catalyst 11 of the catalyst slurry 10, which is sucked into the suction/discharge port side piping 43 through the suction valve side piping 41, from entering into the inside of a diaphragm assembly 52 of the positive displacement pump 5. Furthermore, the suction/discharge port side piping 43 is filled with the solvent 12 used when preparing the catalyst slurry 12 so as to inhibit an interference even if the solvent 12 contacts the catalyst slurry 10, which is sucked.

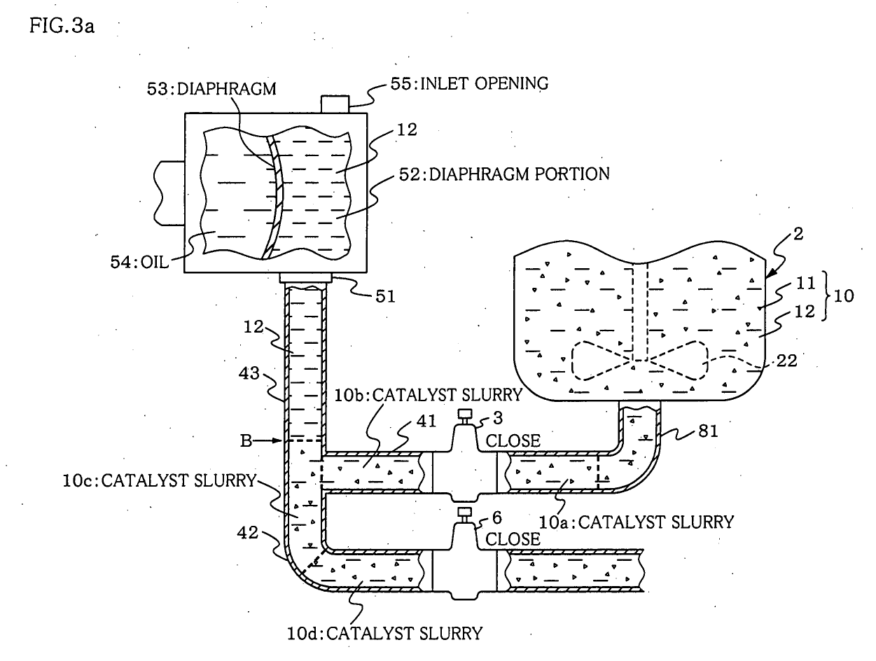

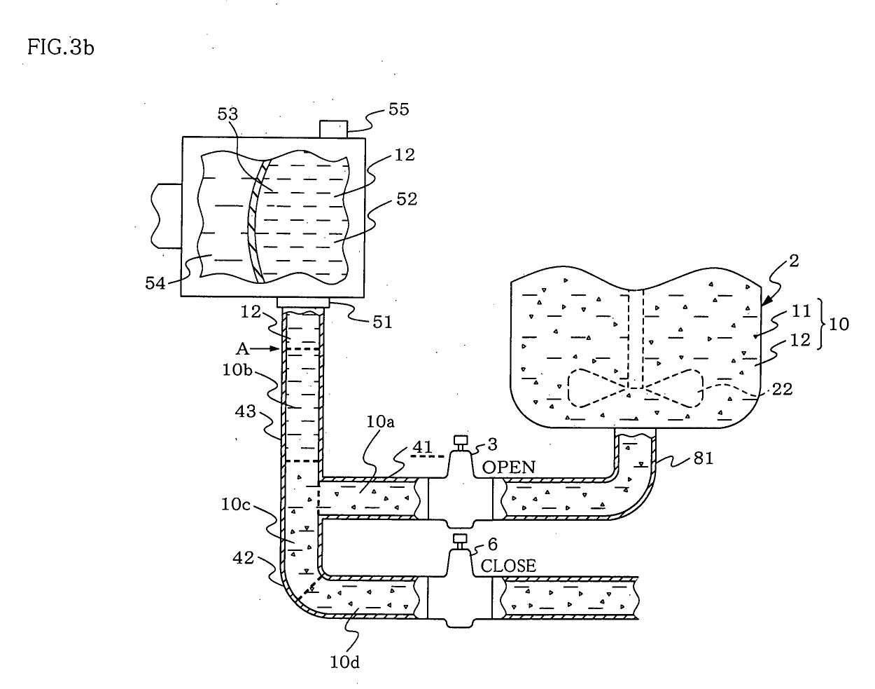

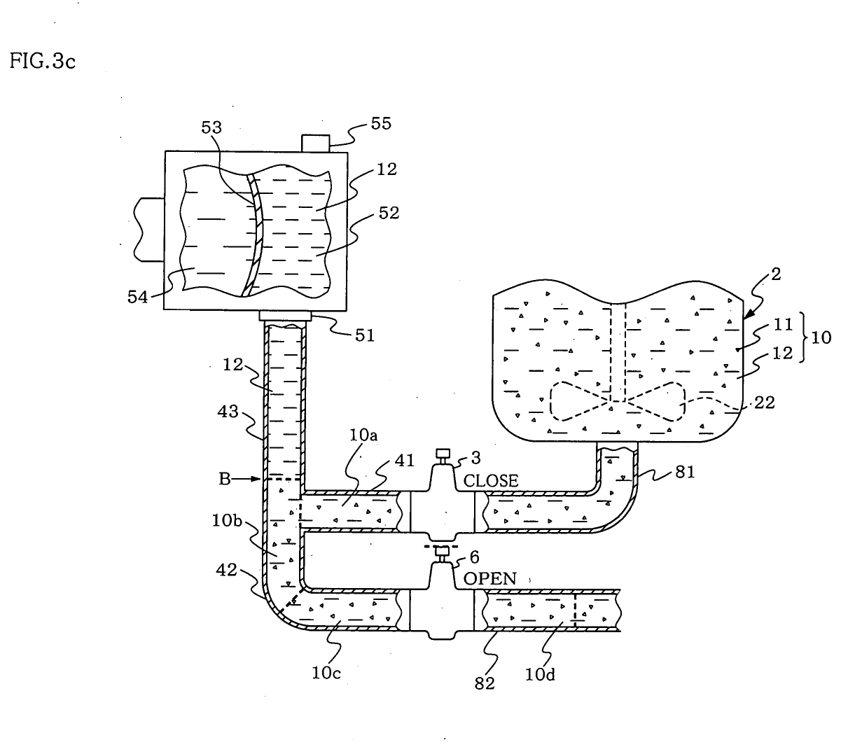

The positive displacement pump 5 is structured such that the common suction/discharge port 51 is provided in place of the suction port and the discharge port, and the solvent 12 is enclosed in the diaphragm assembly 52 (see FIG. 3a). And, the automatic suction valve 3 and the automatic discharge valve 6 serve as a check valve provided in the suction port and the discharge port in the general positive displacement pump.

And preferably, the positive displacement pump 5 may be integrally structured with functions of the automatic suction valve 3, automatic discharge valve 6 and the suction/discharge port side piping 43, and thus structured, a small and space-saving catalyst supply device 1 may be obtained. Furthermore, a small positive displacement pump 5 having a simple structure may be obtained to reduce cost of production thereof.

The positive displacement pump 5 of this embodiment is a diaphragm pump, and a driving source side of the diaphragm 53 thereof is filled with oil 54, and the diaphragm 53 may be reciprocated by an increase and decrease of the oil 54. Meanwhile, a mechanism to reciprocate the diaphragm 53 is not limited to the above-described mechanism, and, the mechanism may be such that a rod connected to a center portion of the diaphragm 53 is reciprocated, for example.

And, the positive displacement pump 5 is the positive displacement pump structured such that the catalyst slurry 10 is not directly sucked in the diaphragm assembly 52 (remote head type), by enclosing the solvent 12 in the diaphragm assembly 52 and the suction/discharge port side piping 43. Thereby, it becomes possible to inhibit a problem that the catalyst 11 sediments around the diaphragm 53 to interfere a normal operation of the diaphragm 53, thereby causing a reduction of a discharge volume. And, a problem that the catalyst 11 sediments in the suction/discharge port 51 to cause blockage may also be inhibited.

The automatic discharge valve 6 is connected to the reaction vessel 7 by means of the piping 82. The automatic discharge valve 6 is automatically controlled to open when the positive displacement pump 5 discharges, and to close when the pump 5 does not discharge, contrary to the above-described automatic suction valve 3.

And, the catalyst supply device 1 may be structured such that a valve 83 is disposed on a reaction vessel 7 side of the piping 82, and the piping 82 diverges in an upstream side of the valve 83 to interpose a valve 84 and a return piping 85 between the same and the catalyst slurry supply vessel 2. By doing so, a cyclic operation, in which the catalyst slurry 10 is returned to the catalyst slurry supply vessel 2 without being supplied to the reaction vessel 7, may be performed, so that it becomes possible to confirm beforehand or periodically, whether the catalyst slurry 10 can be supplied in a stable state in which the catalyst 11 does not sediment in the pipings 81, 82 or the like, or not, by measuring the concentration of the catalyst slurry 10 returned to the catalyst slurry supply vessel 2.

Meanwhile, the catalyst supply device 1, which a actually fabricates a chemical such as polyolefin or the like, may stably supply the catalyst 11 to the reaction vessel 7, without providing the return piping 85.

And, an inner diameter (D (mm)) of a flow path, through which the catalyst slurry 10 flows (for example, the pipings 81, 41, 42, 82, 85, or the like), may be set to be larger than 2 mm and smaller than the inner diameter (D_{MAX} (mm)) of the flow path, in which an average linear flow rate calculated from a set flow volume of the catalyst slurry 10 in operation is approximately 3.0 cm/s. This is because when the inner diameter (D (mm)) is smaller than approximately 2 mm, the piping may be blocked, and when the average linear flow rate is smaller than approximately 3.0 cm/s, the catalyst 11 may sediment in the pipings 81, 41, 42, 82, 85, or the like to cause the blockage at higher risk. Meanwhile, by setting the above-mentioned inner diameter D (mm) smaller than D_{MAX} (mm), the average linear flow rate of the catalyst slurry 10 being carried becomes larger than approximately 3.0 cm/s.

Furthermore, preferably, the inner diameter (D (mm)) may be set to be larger than 2.5 mm, and by doing so, the blockage may be more surely inhibited.

Meanwhile, the above-mentioned flow path is not limited to the pipings 81, 41, 42, 82 and 85, and includes an inner flow path in the automatic suction valve 3, the automatic discharge valve 6, a flow meter 9, or the like. And, inner surfaces of the pipings 81, 4, 82, and 85 are preferably smooth, such that the catalyst slurry 10 flows smoothly.

In this embodiment, the piping 82 is provided with the flow meter 9 for measuring the flow volume of the catalyst slurry 10. Although a general-purpose Coriolis flow meter is used as the flow meter 9, the flow meter is not limited to this, and a laser reflective type (Lasentech-made FMBA D600R, or the like) catalyst concentration measurement instrument or the like may also be used, for example.

However, in the Coriolis flow meter, the blockage occurs when the inner diameter thereof is too small, and the catalyst sediments when the diameter thereof is too large, so that it is necessary to select the flow meter 9 having an appropriate inner diameter.

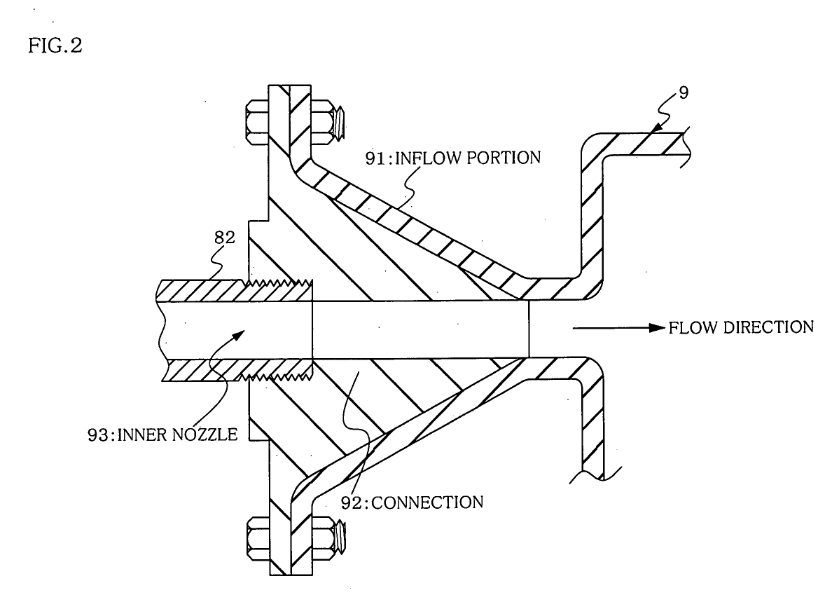

And, when providing the flow meter 9 on the piping 82, if a diameter of an inflow portion 91 of the flow meter 9 is larger than the inner diameter of the piping 82, as shown in FIG. 2, an inner nozzle 93 may be used as a connection 92 to connect the flow meter 9 and the piping 82. In this manner, by making the connection with the piping 82 an inner nozzle structure, it becomes possible to inhibit the flow path of the connection 92 of the piping 82 and the inflow portion 91 from enlarging, thereby inhibiting a problem that the catalyst 11 sediments in the connection 92.

And, the catalyst supply device 1 is preferably structured such that the flow path, through which the catalyst slurry 10 is supplied to the catalyst slurry supply vessel 2, is provided with a filter. In this embodiment, as shown in FIG. 1, a filter 94, which eliminates coarse grain of the catalyst 11, is provided on the piping 86, through which the catalyst slurry 10 is supplied from a catalyst slurry supply source 95 to the catalyst slurry supply vessel 2. When a mesh of the filter 94 is too small, the catalyst 11 cannot pass therethrough, and when this is too large, the blockage of the piping occurs due to the coarse grain, so that in this embodiment, this is set to be not larger than approximately 40% of the smallest inner diameter of the flow path of the catalyst slurry 10. By doing so, it becomes possible to surely inhibit the problem that the flow path, such as each of the pipings 84, 4, 82, 84 and the flow meter 9, or the like, is blocked due to the large coarse grain of the catalyst 11. Meanwhile, a lower limit of the mesh size varies according to a particle size and a distribution of the particles of the catalyst to be passed therethrough, but in general, this may be set to be ten times of the average particle size of the catalyst or larger.

Meanwhile, although a container including a net is generally used as the filter 94, a punching plate or the like may be used in place of the net. And, means for supplying the catalyst slurry 10 having only the catalyst 11 of a predetermined size is not specifically limited, and any means for supplying the catalyst 11 of the predetermined size, when bringing the catalyst slurry 10 in the catalyst slurry supply vessel 2, may be used.

And, the catalyst 11 may be the catalyst containing the transition metal component used in the fabrication process of polyolefin, and the reaction vessel 7 may be the reaction vessel for fabricating polyolefin. In this manner, by using the catalyst supply device 1 in the fabrication process of polyolefin, a stable chemical reaction may be realized to fabricate extremely high quality polyolefin.

Next, an operation of the above-structured catalyst supply device 1 will be described with reference to the drawings.

FIG. 3a is a schematic enlarged cross-sectional view of a state before starting suction, for illustrating the operation of the catalyst supply device according to the present invention.

In the drawing, the prepared catalyst slurry 10 is placed in the catalyst slurry supply vessel 2, and the catalyst slurry 10 is maintained in a substantially homogeneous state, by the agitating blade 22 agitating such that the catalyst 11 does not sediment.

And, the piping 81, and the suction valve side piping 41 and the discharge valve side piping 42 of the three-way piping 4, are filled with the catalyst slurry 10, and the diaphragm assembly 52 of the positive displacement pump 5 and the suction/discharge port side piping 43 are filled with the solvent 12 from the inlet opening 55.

In the above-described initial state, the automatic suction valve 3 and the automatic discharge valve 6 close, and the most inferior point of the solvent 12 filled in the suction/discharge port side piping 43 is at a discharge lower limit level B.

And, as a matter of convenience, the catalyst slurry 10 in the piping 81, the suction valve side piping 41, and the discharge valve side piping 42 is divided into catalyst slurries 10a, 10b, 10c and 10d in the order from the upstream side, and is shown as divided by the bold-dot line so as to be comprehensive.

As shown in FIG. 3b, when the diaphragm 53 of the positive displacement pump 5 starts the suction, the automatic suction valve 3 opens and the automatic discharge valve 6 remains closed.

When the diaphragm 53 continues the suction, in the suction/discharge port side piping 43, a predetermined volume of the catalyst slurry 10a is sucked in the suction valve side piping 41 through the automatic suction valve 3.

When the diaphragm 53 arrives the end point of the suction, the most inferior point of the solvent 12 filled in the suction/discharge port side piping 43 is at a suction upper limit level A. That is to say, the catalyst 11 contained in the catalyst slurry 10b does not enter into the diaphragm assembly 52, so that it is possible to inhibit the problem that the catalyst 11 sediments in the diaphragm assembly 52, thereby reducing the discharge volume or stopping discharge.

And, when the predetermined volume of the catalyst slurry 10a is sucked in the suction valve side piping 41, the automatic suction valve 3 closes and the automatic discharge valve 6 remains closed.

Next, before the diaphragm 53 of the positive displacement pump 5 starts the discharge, the diaphragm 53 moves by a minute distance toward a discharge direction, and pressurizes a sealed region, that is, the solvent 12 in the diaphragm assembly 52 and in the suction/discharge port side piping 43, and the catalyst slurries 10a, 10b, 10c and 10d.

In this manner, the region is pressurized to a higher pressure than an inner pressure of the reaction vessel 7, before the automatic discharge valve 6 opens, so that it is possible to inhibit the problem that the positive displacement pump 5 is shocked by the inner pressure of the reaction vessel 7 when the automatic discharge valve 6 opens.

Next, as shown in FIG. 3c, the automatic discharge valve 6 opens (the automatic suction valve 3 remains closed), and the diaphragm 53 moves toward the discharge direction, thereby the catalyst slurry 10b sucked in the suction/discharge port side piping 43 is forced into the discharge valve side piping 42, and the catalyst slurry 10d exiting in the discharge valve side piping 42 is discharged to the piping 82 through the automatic discharge valve 6.

And, by repeating the above-described cycle, it becomes possible to stably supply a predetermined volume of the catalyst slurry 10 to the reaction vessel 7.

In this manner, according to the above-described catalyst supply device 1, the catalyst 11 does not enter into the diaphragm assembly 52 of the positive displacement pump 5, so that it is possible to inhibit the problem that the catalyst 11 sediments in the diaphragm assembly 52, thereby reducing the discharge volume or completely stopping the discharge due to the blockage. And the catalyst slurry 10 may be stably supplied to the reaction vessel 7.

### EXAMPLE 1

Next, an example of using the catalyst supply device according to the present invention will be described.

Approximately 700 mL of the catalyst slurry 10 prepared so as to be approximately 180 g/L was placed in the catalyst slurry supply vessel 2 with the agitator, having the maximum capacity of approximately 1 L, and pressurized up to approximately 0.147 MPa with nitrogen (N₂) gas, then the agitating blade 22 was agitated at approximately 150 min⁻¹ to obtain the catalyst slurry 10 in a substantially homogeneous state.

As the positive displacement pump 5, the diaphragm pump Z104DD-40VS from Fuji Pump Co., Ltd. was used.

The diaphragm pump was structured such that the automatic suction valve 3 and the automatic discharge valve 6 were automatically controlled by the pneumatic actuator, operating in conjunction with the operation of the diaphragm 53. And the automatic suction valve 3, the automatic discharge valve 6 and the suction/discharge port side piping 43 were integrally structured with the positive displacement pump 5.

Next, the piping 81 from the catalyst slurry supply vessel 2 to the automatic suction valve 3, the suction valve side piping 41 and the discharge valve side piping 42 (inner diameter of each piping was set to approximately 3.76 mm) were filled with heptane, which is an inactive solvent, subsequently, the solvent 12 was enclosed in the diaphragm assembly 52 and the suction/discharge port side piping 43.

Then, after the valve 83 was closed and the valve 84 was opened, the positive displacement pump 5 was operated to perform the cyclic operation, in which the catalyst slurry 10 discharged by the positive displacement pump 5 was returned to the catalyst slurry supply vessel 2. By the cyclic operation, it was confirmed that there was no blockage in the pipings 81, 41, 42, 82, or the like.

Subsequently, the valve 84 was closed, and the valve 83 was opened for approximately one minute, and the flow volume of the catalyst slurry 10 was actually measured to confirm that there was no blockage in the piping 82 between the valve 83 and the reaction vessel 7.

Next, as a flow volume measurement experiment, first, the reaction vessel 7 was pressurized up to approximately 0.147 MPa, the automatic suction valve 3 was opened, the automatic discharge valve 6 was closed, then the catalyst slurry 10 was sucked by the positive displacement pump 5 (step S1).

Next, the automatic suction valve 3 and the automatic discharge valve 6 were closed, and the sucked catalyst slurry 10 was pressurized up to a pressure higher than approximately 0.147 MPa, by the positive displacement pump 5 (step S2).

Subsequently, the automatic discharge valve 6 was opened while the automatic suction valve 3 remained closed, and the pressurized catalyst slurry 10 was supplied to the reaction vessel 7 (step S3).

Meanwhile, the time elapsed from pressurizing of the reaction vessel 7 up to approximately 0.147 MPa to supplying of the pressurized catalyst slurry 10 to the reaction vessel 7 is approximately 30 seconds. Making this one cycle, the cycle was repeated for approximately 176 hours, and the flow volume of the catalyst slurry 10 to be supplied to the reaction vessel 7 was measured at every predetermined time.

Meanwhile, since both of the catalyst slurry supply vessel 2 and the reaction vessel 7 were pressurized up to approximately 0.147 MPa, a differential pressure therebetween was approximately 0 MPa-abs.

As shown in Table 1, the flow volume was extremely stable. For example, although the flow volume varies by the blockage of the piping or the like when the catalyst 11 sediments, such variation almost never occurred, so that the catalyst slurry 10 was supplied in an extremely stable state.

And, the average flow volume was approximately 0.73 cm³/s (=approximately 2.64 L/hr), and the average linear flow rate was approximately 6.6 cm/s.

### EXAMPLE 2

And, the reaction vessel 7 was pressurized up to approximately 0.98 MPa with nitrogen (N²) gas, in advance, to make the differential pressure between the same and the catalyst slurry supply vessel 2 approximately 0.833 MPa-abs, and the flow volume was measured as in the Example 1. The flow volume was extremely stable as shown in the above Table 1.

And the average flow volume was approximately 0.69 cm³/s (=approximately 2.50 L/hr), and the average linear flow rate was approximately 6.3 cm/s.

The experimental results of the Examples 1 and 2 were shown in the Table 1.

TABLE 1
Experimental Results

Differential Pressure between the
Catalyst Slurry Supply Vessel and the
Reaction Vessel

| | Example 1 | Example 2 |
|---|---|---|
| Time | 0 MPa-abs | 0.833 MPa-abs |
| Elapsed (hr) | Flow Volume (L/hr) | Flow Volume (L/hr) |
| 0 | 2.76 | 2.49 |
| 23 | 2.49 | 2.58 |
| 46 | 2.61 | 2.52 |
| 70 | 2.67 | 2.55 |
| 95 | 2.46 | 2.34 |
| 118 | 2.64 | 2.46 |
| 150 | 2.76 | 2.58 |
| 176 | 2.70 | — |
| Average Flow | 0.73 | 0.69 |
| Volume (cm³/s) | | |
| Average Linear | 6.6 | 6.3 |
| Flow (cm/s) | | |

### COMPARATIVE EXAMPLE 1

In the Example 1, the general-purpose diaphragm pump (EKMs-1) from TEIKOKU ELECTRIC MFG CO., LTD. having a check valve was used in place of the positive displacement pump 5 equipped with function of the automatic suction valve 3, the three-way piping 4, and the automatic discharge valve 6, and the check valve regularly attached to the pump was used in place of the automatic suction valve 3 and the automatic discharge valve 6.

As a result, the pump was only capable of an extremely short time operation (few seconds to few dozen of seconds). This was because the catalyst 11 blocked the check valve, and the discharge therefrom became unavailable. Furthermore, the catalyst 11 also was deposited around the diaphragm.

### COMPARATIVE EXAMPLE 2

In the Example 1, the NEMO Pump (3NE06H2) from HEISHIN LTD. was used in place of the positive displacement pump 5 equipped with function of the automatic suction valve 3, the three-way piping 4, and the automatic discharge valve 6.

As a result, a variation of the flow volume in a variation of differential pressure (differential pressure were approximately 0.00 MPa-abs and approximately 0.833 MPa-abs) between a gauging vessel and the catalyst slurry supply vessel 2 was large, as compared with the Example 1, and in addition, when the differential pressure was especially large (in the case in which the differential pressure was set to approximately 0.833 MPa-abs), agglomeration of the catalyst 11 particles was generated in the pump, so that the stable supply was not possible.

### COMPARATIVE EXAMPLE 3

In the Example 1, the set flow volume was reduced to approximately 1.2 L/hr (average linear flow rate of approximately 3.0 cm/s). As a result, the flow volume was stable for approximately 20 to 23 hours, but after that, the piping was somewhat blocked, so that the stable supply of the catalyst slurry 10 was not possible.

### EXAMPLE 3

In the Example 1, the flow meter 9 was placed on the return piping 85 from the discharge of the positive displacement pump 5 to the catalyst slurry supply vessel 2, and a reciprocating speed of the diaphragm 53 is continuously changed at the differential pressure of approximately 0.833 MPa-abs, thereby continuously changing the flow volume of the catalyst slurry 10 between two levels of the set flow volume of approximately 2.5 L/hr and of approximately 5.0 L/hr.

By this experiment, it was confirmed that the flow volume control and the stable operation were possible, by correcting a detected flow volume by a moving-average method and automatically controlling the opening and closing speed of the valve.

Meanwhile, as the flow meter 9, the Coriolis flow meter (D12 (inner diameter of approximately 2.87 mm) from OVAL Corp.) was used, and the inner nozzle 86 was used at the connection of the same and the flow meter 9.

And the experiment using the meter from SAKURA Endless Co., LTD. (63ACO₄) and that from the Oval Corp. (CN003C-SS-999R) as the similar flow meter 9 was also performed.

From the experiment, it was confirmed that the flow volume control and the stable operation were possible by using any of the above-described flow meter.

### COMPARATIVE EXAMPLE 4

It was set as in the Example 3, except that the inner nozzle structure was not used.

As an experimental result, the catalyst 10 was deposited at the inlet opening of the flow meter 9 to occur the blockage, when rebooting the positive displacement pump 5 after a temporally stop thereof in a state in which the catalyst slurry 10 stayed in the piping, in a filling operation of the catalyst slurry 10.

### EXAMPLE 4

It was set as in the Example 3, except that the piping 87, the filter 94, and the catalyst slurry supply source 95 were placed on the upstream side of the catalyst slurry supply vessel 2. Meanwhile, the catalyst slurry prepared at the catalyst slurry supply source 95 was supplied from the catalyst slurry supply source 95 to the catalyst slurry supply vessel 2 through the filter 94 and the piping 87. Herein, the mesh size of the filter 94 was set to approximately 1.0 mm, and the catalyst, having the particle size smaller than the mesh size was supplied to the catalyst slurry supply vessel 2.

As an experimental result, it was confirmed that the flow volume control and the stable operation were possible by correcting the detected flow volume by the moving-average method and automatically controlling the opening and closing speed of the valve. And, when testing the above-described three kinds of the flow meter 9 with the inner nozzle 86 provided, it was confirmed that the flow volume control and the stable operation were possible by using any of the flow meter 9.

### COMPARATIVE EXAMPLE 5

It is set as in the Example 4, except that the filter 94 was removed and the prepared catalyst slurry containing approximately 10 coarse grain catalyst particles (catalyst having a particle size of approximately 1.18 mm to 1.41 mm (catalyst having a particle size of approximately 41 to 50% of the minimum inner diameter of approximately 2.87 mm of the flow path of the catalyst slurry)) was forcedly supplied to the catalyst slurry supply vessel 2.

As an experimental result, the catalyst 11 blocked the flow meter 9 (Coriolis flow meter) after approximately five minutes, and the catalyst slurry supply was stopped.

Although the preferred embodiment of the catalyst supply device of the present invention has been described above, it goes without saying that the catalyst supply device according to the present invention is not limited to the above-described embodiment, and that a variety of modifications are possible in the scope of the present invention.

For example, the positive displacement pump is not limited to the diaphragm pump, and any type of the positive displacement pump having the structure in which the catalyst 11 does not enter into the diaphragm assembly 52, may be used.

### INDUSTRIAL APPLICABILITY

Although the catalyst supply device of the present invention is described as the device for stably supplying the catalyst slurry, the device is not limited to this application. By supplying the slurry containing solid substance other than the catalyst, the present invention may be applicable as the solid substance supplying device.

1. A catalyst supply device for supplying catalyst slurry from a catalyst slurry supply vessel to a reaction vessel by means of a positive displacement pump, wherein
said catalyst slurry supply vessel, the reaction vessel and the positive displacement pump are connected to one another by means of three-way piping,
an automatic suction valve, which opens when said positive displacement pump sucks and closes when said pump does not suck, is interposed between said catalyst slurry supply vessel and a crossing of said three-way piping,
an automatic discharge valve, which opens when said positive displacement pump discharges and closes when said pump does not discharge, is interposed between said reaction vessel and the crossing of said three-way piping,
an enclosed fluid is enclosed in said positive displacement pump and at least a part of piping between said positive displacement pump and the crossing of said three-way piping, and
a predetermined volume of the catalyst slurry is sucked from said catalyst slurry supply vessel into the piping between the crossing of said three-way piping and said positive displacement pump through said automatic suction valve when said positive displacement pump sucks, and the predetermined volume of said catalyst slurry is discharged through said automatic discharge valve to be supplied to said reaction vessel when said positive displacement pump discharges.

2. The catalyst supply device according to claim 1, wherein said automatic discharge valve opens after said positive displacement pump starts discharge.

3. The catalyst supply device according to claim 1 or 2, wherein said positive displacement pump is a diaphragm pump, and the fluid enclosed in said diaphragm assembly is the same as a solvent which is used for said catalyst slurry, further the piping between the crossing of said three-way piping and said positive displacement pump is placed above the crossing of said three-way piping.

4. The catalyst supply device according to claim 1 or 2, wherein said positive displacement pump, and said automatic suction valve, the automatic discharge valve and the crossing of said three-way piping are integrally structured.

5. The catalyst supply device according to claim 1 or 2, wherein an inner diameter of a flow path through which said catalyst slurry flows is set to be larger than 2 mm, and is set such that an average linear flow rate calculated from the flow volume of the catalyst slurry is larger than 3.0 cm/s.

6. The catalyst supply device according to claim 1 or 2, wherein when providing a measurement instrument in the flow path of said catalyst slurry, a connection of said measurement instrument and the flow path is an inner nozzle structure.

7. The catalyst supply device according to claim 1 or 2, wherein said catalyst slurry supply vessel has an agitating blade.

8. The catalyst supply device according to claim 1 or 2, wherein a filter is provided in the flow path to supply said catalyst slurry to said catalyst slurry supply vessel.

9. The catalyst supply device according to claim 1 or 2, wherein said reaction vessel is a reaction vessel for fabricating polyolefin.
